(19) United States
(12) Patent Application Publication
(10) Pub. No.: US 2021/0003345 A1
(43) Pub. Date: Jan. 7, 2021

(54) Automated system and method to perform, compute and analyze the cooling curve of quenchants

(71) Applicant: Thupaki Sanjivachar Prasanna Kumar, Bengaluru (IN)

(72) Inventor: Thupaki Sanjivachar Prasanna Kumar, Bengaluru (IN)

(21) Appl. No.: 16/459,616

(22) Filed: Jul. 2, 2019

(51) Int. Cl. F27B 17/00; C21D 1/62; G01K 7/02; F27D 11/02; G06F 13/42

(52) U.S. Cl. CPC F27B 17/00; C21D 1/62; G06F 2213/0042; F27D 11/02; G06F 13/4282; G01K 7/023

(57) ABSTRACT

The present invention provides an automated system (100) for performing a cooling curve analysis for a plurality of quenchants wherein the system (100) comprises a quench probe (101) which is heated up to a maximum pre-defined temperature by an electric resistance furnace (102). Further, the quench probe (101) is automatically transferred and inserted into a quench vessel (107) after being heated to a maximum pre-defined temperature. The quench probe (101) is retained in the quench vessel (107) till the temperature of the quench probe (101) gradually decreases to a pre-defined minimum temperature as indicated by a Universal Serial Bus (USB) data logger (106) which logs the temperature of the quench probe (101) and indicates a graphical representation of the cooling curve analysis through the process automation tool installed on a computer hardware device.

### TECHNICAL FIELD OF THE INVENTION

The present invention provides an automated system and method for performing, computing and analyzing the cooling curve of a plurality of quenchants. Further, the present invention allows the user(s) to simultaneously compare the results obtained after the completion of the cooling curve analysis performed for a plurality of quenchants using a process automation tool.

### BACKGROUND OF THE INVENTION

Spare parts in machines such as gear wheels, hydraulic cylinders and auto components are heat treated to provide strength and wear resistance to the components involved. Quench heat treatment is a hardening heat treatment process, wherein the parts employed are normally disposed in a steel container, heated to a temperature of approximately 850 degree Celsius in a furnace and immersed into a tank containing liquids or quenchants such as mineral oil, water, salt baths and so on.

One of the most important tests performed on quenchants for heat treatment of steels is to generate the cooling curve and cooling rate curves to select the appropriate quenchant for a particular grade of steel which gives the desired hardness. The quenching medium is required to be tested periodically for alterations caused by external factors such as contamination, oxidation and so on.

As a result of increased cost and lack of availability of the test system, most of the heat treaters in the small and medium sector ignore the test until they begin to encounter defects such as cracks or soft spots which begin to decrease their profitability. Further, the existing systems employ a manual approach for testing the quenchant(s) which raises several concerns with respect to the safety of the user(s) and the accuracy of the results obtained.

The Patent Application number U.S. Pat. No. 6,648,997 titled “Quenching method” discloses a method of quenching a hot metal object formed of steel, the method includes immersing the hot metal object in a suspension of an essentially insoluble inorganic particulate material in water, the suspension being initially at a temperature below 100 degree C. The method according to the invention is suitable for treatment of alloys such as engineering steels that undergo an austenite-martensite transition during quenching or otherwise require a relatively slow cooling rate. In addition, the method is particularly suitable for treatment of high alloyed steels or tool steels which do not require a fast-initial cooling rate, which would crack if cooled too quickly. Examples of such steels are molybdenum or tungsten high speed tool steels. The quenchant also has the advantage of not causing any substantial disposal problems.

The Patent Application number U.S. Pat. No. 6,723,188 titled “Steel workpiece oil quenching method” discloses a steel workpiece maintained at a specified quenching temperature which is rapidly cooled to a temperature just above the martensite transformation start point (Ms point) by being inserted into a high-temperature quenching oil. Thereafter, the steel workpiece is taken out of the high-temperature quenching oil so as to be soaked by the heat possessed by the steel workpiece and subsequently cooled by being inserted into the high-temperature quenching oil. Through these processes, a temperature difference between steel workpieces or the portions of a steel workpiece in the martensite transformation stage is reduced, and a cooling speed in a high-temperature region (not lower than about 550 degree C.) is made to be a slow speed sufficient for restraining a thermal distortion, by which the quenching distortion and quenching variation can be reduced.

### SUMMARY OF THE INVENTION

The present invention overcomes the drawbacks of the prior art by providing an automated system and method to perform and compute a cooling curve analysis for a plurality of quenchants, wherein the system comprises a quench probe which is heated up to a maximum pre-defined temperature of at least 850 degree Celsius through an electric resistance furnace. The quench probe is immersed in the quenchant held in the quench vessel after being heated to a maximum pre-defined temperature by the electric resistance furnace. Further, the system comprises a Universal Serial Bus (USB) data logger which is removably connected to the quench probe, wherein the USB data logger is calibrated by a process automation tool prior to the process of heating the quench probe. An automated probe transfer unit is employed for automatically transferring the quench probe from the electric resistance furnace to the quench vessel containing a pre-determined quantity of quenchant after being heated up to a maximum pre-defined temperature of at least 850 degree Celsius.

The present invention also provides an automated method for computing and analyzing the cooling curve of quenchants wherein the process automation tool is employed for calibrating the USB data logger for parameters such as temperature units, type of thermocouple employed, logging frequency of the USB data logger and an alerting mechanism which indicates the user(s) when the temperature of the quench probe reaches a maximum pre-defined temperature of at least 850 degree Celsius. The process automation tool also provides a graphical representation of the cooling curve which is derived by employing one or more quenchants in the quench vessel. The method enables the user(s) to simultaneously compare the results of the cooling curve analysis obtained using a plurality of quenchants and save the cooling curve process parameter(s) on the computer hardware device in a printable format.

The present invention provides a portable and cost-effective solution for the performance of cooling curve analysis using a plurality of quenchants. The system is sensitive to any alteration observed in quenchant properties through the results obtained in the cooling curve analysis. Further, the system employed for performing the cooling curve analysis is calibrated and tested against standard industry conventions and is proven to yield accurate results.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1a illustrates an orthogonal front view of the system comprising a quench probe which is inserted into an electric resistance furnace.

FIG. 1b illustrates an orthogonal front view of the system comprising a quench probe which is inserted into a quench vessel that contains a pre-determined quantity of quenchant(s).

FIG. 1c illustrates an orthogonal front view of the automated probe transfer unit for automatically transferring the quench probe from the electric resistance furnace to the quench vessel.

FIG. 2 illustrates a method for computing a cooling curve analysis for a plurality of quenchants using a process automation tool.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention provides an automated system to perform a cooling curve analysis for a plurality of quenchants wherein the system comprises a quench probe which is heated up to a maximum pre-defined temperature of at least 850 degree Celsius by an electric resistance furnace. Further, the system comprises a quench vessel for containing a pre-determined quantity of quenchant, wherein the quench probe is inserted into the quench vessel after being heated to a maximum pre-defined temperature by the electric resistance furnace. The quench probe is retained in the quench vessel till the temperature of the quench probe gradually decreases to a pre-defined minimum temperature which is indicated by a Universal Serial Bus (USB) data logger which is removably connected to the quench probe and calibrated by a process automation tool prior to the process of heating the quench probe. The USB data logger logs the rate of cooling of the quench probe and indicates a graphical representation of the cooling curve analysis through the process automation tool installed in a computer hardware device.

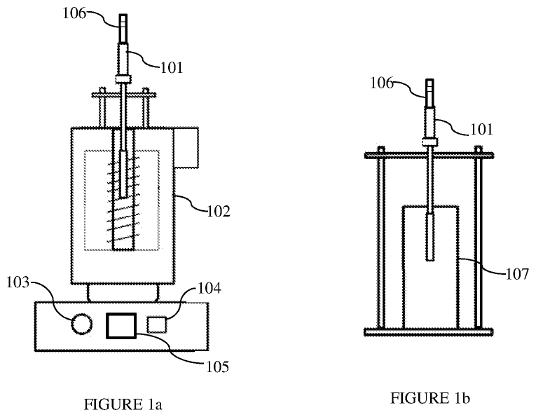

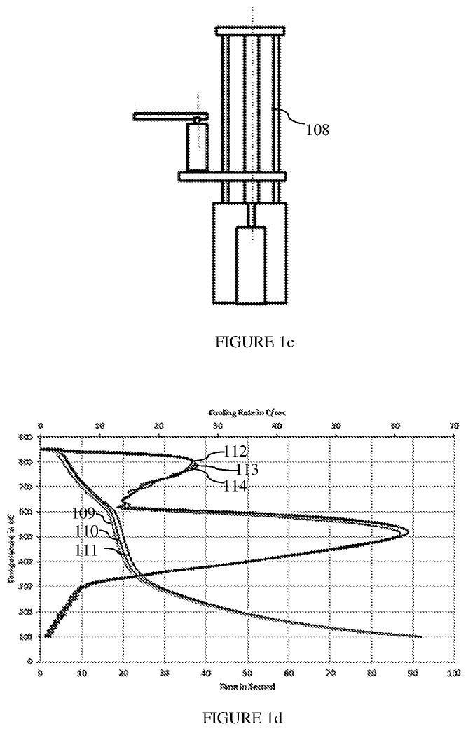

FIG. 1a illustrates an orthogonal front view of the system comprising a quench probe which is inserted into an electric resistance furnace. The system (100) comprises a quench probe (101) which is provided with a unique identification code that is etched on the external surface of the quench probe (101). A thermocouple employed within the quench probe (101) may be firmly secured to the quench probe (101) through a collet which facilitates continuous contact between the thermocouple and the quench probe (101) thereby yielding results with a high level of accuracy. Further, the quench probe (101) is heated up to a maximum pre-defined temperature of at least 850 degree Celsius by an electric resistance furnace (102) which comprises a manual switch (103) for powering on or powering off the electric resistance furnace (102), a display (104) for indicating the temperature of the electric resistance furnace (102) and an input mechanism (105) for controlling the maximum temperature of the electric resistance furnace (102), wherein the input mechanism (105) may be disposed on the external surface of the electric resistance furnace (102). The electric resistance furnace (102) is pre-heated to a pre-defined temperature before the quench probe (101) is inserted into the electric resistance furnace (102).

According to one or more embodiments of the present invention, the quench probe may be firmly secured to a thermocouple through a collet

According to one or more embodiments of the present invention, the system (100) comprises a Universal Serial Bus (USB) data logger (106) which is removably connected to the quench probe (101), wherein the USB data logger (106) comprises a display to indicate a plurality of process parameters and an alerting mechanism which prompts the user(s) when the electric resistance furnace (102) reaches a maximum pre-defined temperature. The USB data logger (106) is connected and secured to the quench probe (101) through a protective sleeve which ensures that the USB data logger (106) is firmly secured to the quench probe (101). Once the USB data logger (106) is calibrated by a process automation tool prior to the process of heating the quench probe (101), it is connected to the quench probe (101) which is inserted into the pre-heated electric resistance furnace (102) and subjected to a maximum pre-defined temperature of at least 850 degree Celsius.

FIG. 1b illustrates an orthogonal front view of the system comprising a quench probe which is inserted into a quench vessel that contains a pre-determined quantity of quenchant. Once the quench probe (101) is heated to a maximum pre-defined temperature of at least 850 degree Celsius as indicated in FIG. 1a, the quench probe (101) is automatically transferred into a quench vessel (107) which contains a pre-determined quantity of quenchant. The quench probe (101) is retained in the quench vessel (107) till the temperature of the quench probe (101) gradually decreases to a pre-defined minimum temperature which is indicated by the USB data logger (106).

FIG. 1c illustrates an orthogonal front view of an automated probe transfer unit (108) which is an electro-mechanical device which may be controlled using limit switches and relay logic. The automated probe transfer unit (108) is employed for automatically transferring the quench probe (101) from the electric resistance furnace (102) to the quench vessel (107), wherein the quench probe (101) is transferred to the quench vessel (107) containing a pre-determined quantity of quenchant after being heated up to a maximum pre-defined temperature of at least 850 degree Celsius by the electric resistance furnace (102). The automated probe transfer unit (108) enables the heated quench probe (101) to be transferred from the electric resistance furnace (102) to the quench vessel (107) without any direct human contact thereby enabling the user(s) to operate the system (100) from a safe distance.

According to one or more embodiments of the present invention, the heated quench probe (101) may be withdrawn from the electric resistance furnace (102) through a vertical movement using a screw rod which may be driven by a reversible DC motor. Once the quench probe (101) is withdrawn from the electric resistance furnace (102), another reversible DC motor may swivel the quench probe (101) arm to position it above of the quench vessel (107). The quench probe (101) is subsequently lowered into the quench vessel (107) comprising the quenchant with a steady movement. The process of transferring the quench probe (101) from the electric resistance furnace (102) to the quench vessel (107) may be automated by activating a single button which is operated by the operator from a safe distance. Identical movements may be employed in the reverse order to restore the position of the quench probe (101) from the quench vessel (107) to the electric resistance furnace (102).

According to one or more embodiments of the present invention, when the temperature of the quench probe (101) decreases to a pre-defined minimum temperature, the USB data logger (106) is disconnected from the quench probe (101) and interfaced with a computer hardware device through a USB port disposed on the computer hardware device. A process automation tool installed on the computer hardware device is activated for performance of the cooling curve analysis, wherein the USB data logger (106) logs the temperature of the quench probe (101) at a predetermined frequency and indicates a graphical representation of the cooling curve analysis through the process automation tool installed in a computer hardware device.

FIG. 1d indicates a graphical representation of the cooling rate curves obtained using a single quench probe (101) and a single quenchant oil. According to the standard conventions determined by the ASTM 6200, the cooling rate curve is obtained by considering at least four readings of temperature data which is averaged and smoothed thereby yielding inaccurate results. On the contrary, system (100) provides highly accurate results, wherein the data logger (106) logs the temperature at every second of the process which ensures that a time-temperature point is obtained at every second. Further, the process automation tool may pass a spline curve through all the points of time-temperature measurement which yields a highly accurate cooling rate curve. In FIG. 1d, curves (109), (110) and (111) indicate the exponential decrease in temperature of a single quench probe (101) heated in a single quenchant oil during three different instances. The cooling rate curves (112), (113) and (114) indicate that the results obtained while using a single quench probe (101) and a single quenchant oil are repeatable which is a testament to the accuracy in results obtained by system (100).

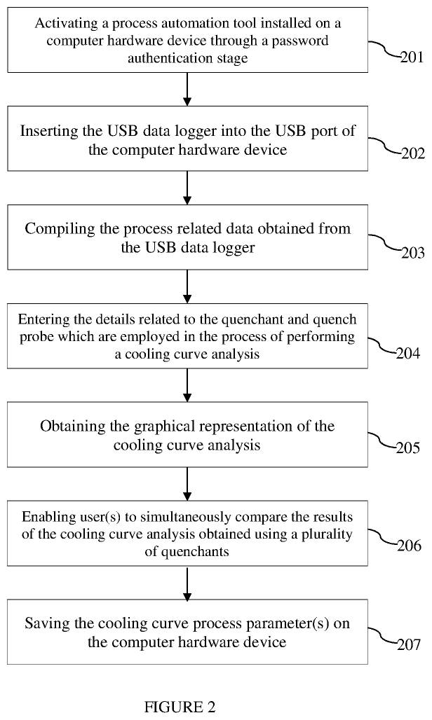

FIG. 2 illustrates a method for computing a cooling curve analysis for a plurality of quenchants using a process automation tool. The method comprises the steps of activating the process automation tool installed on a computer hardware device through a password authentication stage in step (201), wherein the process automation tool is employed for calibrating the USB data logger (106) for parameters such as temperature units, type of thermocouple employed, logging frequency of the USB data logger (106) and alerting mechanism when the temperature of the quench probe (101) reaches a maximum pre-defined temperature of at least 850 degree Celsius.

Further, the method facilitates the USB data logger (106) to be disconnected from the quench probe (101) and interfaces it with a computer hardware device through a USB port disposed on the computer hardware device, wherein the USB data logger is digitally stopped and the data related to the USB data logger is saved on the computer hardware device in step (202).

Upon inserting the USB data logger (106) into a USB port disposed on the computer hardware device, all the process related data such as time versus temperature data measured at every second of the process which are obtained from the USB data logger (106) are compiled in step (203) and the details related to the quenchant(s) and quench probe (101) which are employed in the process of performing a cooling curve analysis are entered in step (204). Once the required details are entered in the process automation tool, a graphical representation of the cooling curve analysis is obtained in step (205). The method (200) enables the user(s) to simultaneously compare the results of the cooling curve analysis obtained using a plurality of quenchants in step (206). The user(s) are provided with an option for saving the cooling curve process parameter(s) on the computer hardware device in a printable format in step (207).

The present invention provides a portable and cost-effective solution for the performance of cooling curve analysis using a plurality of quenchants. The system (100) is sensitive to any alteration observed in quenchant properties through the results obtained in the cooling curve analysis. Further, the system (100) employed for performing the cooling curve analysis is calibrated and tested against standard industry conventions such as ASTM 6200 and ISO 9950 and is proven to yield accurate results.

While at least one exemplary embodiment has been presented in the foregoing detailed description, it should be appreciated that a vast number of variations exist.

### REFERENCE NUMBERS

| Components | Reference Numbers |
|---|---|
| System | 100 |
| Quench Probe | 101 |
| Electric resistance furnace | 102 |
| Manual switch | 103 |
| Display | 104 |
| Input mechanism | 105 |
| Universal Serial Bus (USB) data logger | 106 |
| Quench vessel | 107 |
| Automated probe transfer unit | 108 |

I claim:

1. An automated system for performing a cooling curve analysis for quenchants, the system (100) comprising:
a. a quench probe (101) which is heated up to a maximum pre-defined temperature of at least 850 degree Celsius;
b. an electric resistance furnace (102) for heating the quench probe (101) up to a maximum pre-defined temperature of at least 850 degree Celsius, wherein the electric resistance furnace (102) comprises:
i. a manual switch (103) for powering on or powering off the electric resistance furnace (102); and
ii. a display (104) for indicating the temperature of the electric resistance furnace (102);
iii. an input mechanism (105) for controlling the maximum temperature of the electric resistance furnace (102);
c. a Universal Serial Bus (USB) data logger (106) which is removably connected to the quench probe (101), wherein the USB data logger (106) is calibrated by a process automation tool prior to the process of heating the quench probe (101);
d. a quench vessel (107) for containing a pre-determined quantity of quenchant, wherein the quench probe (101) is inserted into the quench vessel (107) after being heated to a maximum pre-defined temperature of at least 850 degree Celsius by the electric resistance furnace (102);
e. an automated probe transfer unit (108) for automatically transferring the heated quench probe (101) from the electric resistance furnace (102) to the quench vessel (107) containing a pre-determined quantity of quenchant after being heated up to a maximum pre-defined temperature of at least 850 degree Celsius by the electric resistance furnace (102).

2. The automated system as claimed in claim 1, wherein the quench probe (101) is firmly secured to a thermocouple employed within the quench probe (101) through a collet which facilitates continuous contact between the thermocouple and the quench probe (101).

3. The automated system as claimed in claim 1, wherein the quench probe (101) is provided with a unique identification code which is etched on the external surface of the quench probe (101).

4. The automated system as claimed in claim 1, wherein the quench probe (101) is retained in the quench vessel (107) till the temperature of the quench probe (101) gradually decreases to a pre-defined minimum temperature which is indicated by the USB data logger (106).

5. The automated system as claimed in claim 1, wherein USB data logger (106) comprises:
a display to indicate a plurality of process parameters; and
an alerting mechanism which prompts a user(s) when the electric resistance furnace (102) reaches a maximum pre-defined temperature.

6. The automated system as claimed in claim 1, wherein the USB data logger (106) is connected and secured to the quench probe (101) through a protective sleeve which ensures that the USB data logger (106) is firmly secured to the quench probe (101).

7. The automated system as claimed in claim 1, wherein the USB data logger (106) is interfaced with a computer hardware device through a USB port disposed on the computer hardware device.

8. The automated system as claimed in claim 1, wherein the USB data logger (106) logs the temperature of the quench probe (101) and indicates a graphical representation of the cooling curve analysis through the process automation tool installed in a computer hardware device.

9. The automated system as claimed in claim 1, wherein the electric resistance furnace (102) is pre-heated to a pre-defined temperature before the quench probe (101) is inserted into the electric resistance furnace (102).

10. An automated method for computing a cooling curve analysis for quenchants, the method (100) comprising the steps of
a. activating the process automation tool installed on a computer hardware device through a password authentication stage, wherein the process automation tool is employed for calibrating the USB data logger (106) for parameters such as temperature units, type of thermocouple employed, logging frequency of the USB data logger (106) and alerting mechanism when the temperature of the quench probe (101) reaches a maximum pre-defined temperature of at least 850 degree Celsius;
b. inserting the USB data logger (106) into the USB port of the computer hardware device, wherein the USB data logger (106) is digitally stopped, and the data related to the USB data logger (106) is saved on the computer hardware device;
c. compiling the process related data obtained from the USB data logger (106), wherein the USB data logger (106) logs the temperature at every second of the process to obtain a time-temperature point at every second;
d. entering the details related to the quenchant and quench probe (101) which are employed in the process of performing a cooling curve analysis;
e. obtaining the graphical representation of the cooling curve analysis;
f. enabling user(s) to simultaneously compare the results of the cooling curve analysis obtained using a plurality of quenchants;
g. saving the cooling curve process parameter(s) on the computer hardware device.
